(19) United States
(12) Patent Application Publication
(10) Pub. No.: US 2005/0072850 A1
(43) Pub. Date: Apr. 7, 2005

(54) Automatic water temperature control system and method

(76) Inventors: Michael Anthony Cornwall, Moorpark, CA (US); La'Jon Jordan, N. Hollywood, CA (US)

Correspondence Address: Michael Anthony Cornwall, 6462 N. Berkeley Circle, Moorpark, CA, 93021, US

(21) Appl. No.: 10/755,663

(22) Filed: Jan. 9, 2004

Related U.S. Application Data
(60) Provisional application No. 60/319,845, filed on Jan. 9, 2003.

(51) Int. Cl. G05D 23/13

(52) U.S. Cl. 236/12.15; 236/DIG. 8

(57) ABSTRACT

An electromechanical control system that quickly and accurately controls the flow of two primary fluids such that the mixed secondary fluid would be delivered to an end user, such as a shower or bath or the like, at a constant temperature. The invention allows the user to select the temperature of the secondary fluid via a digital control interface. A temperature-sensing element located in the secondary fluid provides a feedback signal to the control electronics. Upon flow of the secondary fluid, the control electronics determine the required flow for each of the two primary valve members and control said flow from each primary valve member via an electronic signal. The output signals control two high flow proportional solenoid valves such that the primary fluid flow is electronically adjusted through a plurality of positions from full on to full off. This constant control algorithm provides quick, accurate, and stable secondary fluid temperature. The present invention allows for user adjustment of the temperature ranging from the cold inlet temperature to the hot inlet temperature, stored temperature settings, scald protection, various flow rates, various flow localities, timing, radio, or other digital features.

I claim the benefit of the filing date of provisional patent No. 60/319,845 filed on Jan. 9, 2003.

### DESCRIPTION OF RELATED ART

U.S. Pat. No. 5,125,433 refers to a system using electronic circuitry to control various valves to deliver a preset water temperature to the end user. This system cannot produce a continuous range of temperature settings for optimal comfort.

U.S. Pat. No. 4,923,116 and U.S. Pat. No. 4,700,884 both disclose the use of electronically operated mixing valves. This method can be very costly due to the general use of motors and motor control drivers to control the system.

U.S. Pat. No. 4,420,811 discloses the use of variable position hot and cold valves which are controlled electronically. This method can be very costly due to the general use of motors and motor control drivers to control the system.

U.S. Pat. No. 4,421,269 discloses the use of a reversible motor that controls the flow of water by means of a differential amplifier and a limiter. This system also can be very costly due to the general use of motors and motor control drivers to control the system.

U.S. Pat. No. 4,281,790 employs the use of a thermostatic valve located at the showerhead that senses and shuts off the flow of water in an over-temperature situation.

U.S. Pat. No. 5,090,436 discloses the use of a temperature sensitive electric one-way valve that automatically shuts off during an over-temperature situation.

The prior art does not solve the total package problem of designing a system that is both user-friendly and cost effective for purpose of manufacturing. All systems previously mentioned that control the water temperature, employ some sort of motor controlled operation or do not control the temperature at all. There is a need in the industry to invent a robust automatic water temperature control system and method that can be made at a low cost and provide reliable, repeatable, and stable results to the end user.

### BACKGROUND OF THE INVENTION

The present invention relates generally to an automatic water temperature control system and method and more particularly to a system that employs the use of high flow proportional solenoid valves and more particularly a system that uses control electronics to dynamically change the excitation current applied to the valves to vary the flow as a general control method.

### SUMMARY OF THE INVENTION

The present invention relates to an automatic water temperature control system that quickly and accurately controls the flow of two primary fluids such that the mixed secondary fluid would be delivered at a constant temperature to the end user, such as a bath or shower or the like. More specifically, a manifold comprising of 4 electrically operated solenoid valves are used in conjunction with a temperature feedback signal and a user control interface to provide a desired mixed secondary fluid temperature to the outlet. More specifically, two inlet high flow proportional solenoid valves will control the primary fluid flow based on varied excitation current signals from a set of control electronics. These signals will be determined based on the user set point from the user control interface and the temperature feedback signal. One inlet valve will be connected to the Hot water supply line. The second inlet valve will be connected to the Cold water supply line. One outlet valve may be connected to either the showerhead or bath faucet. A second outlet valve may be connected to a showerhead or bath faucet if both a showerhead and bath faucet are employed in the same system. The primary fluid flow of both the Hot and Cold inlet valves will be proportionally controlled via changes in the excitation current of said valves. By changing the flow of each inlet valve, a constant temperature can be achieved in the resulting mixed secondary fluid.

### BRIEF DESCRIPTION OF THE DRAWINGS

FIG. 1. is a block schematic of the control system employed by the present invention.

FIG. 2. is a view of a bathtub and shower which has been provided with the present invention installed.

FIG. 3. is a side view of the present invention shown in FIG. 5.

FIG. 4. is an example of a user control interface that may be employed by the present invention.

FIG. 5. is an example of the configuration and objects that may be present on the Manifold assembly.

### DESCRIPTION OF THE PREFERRED EMBODIMENT

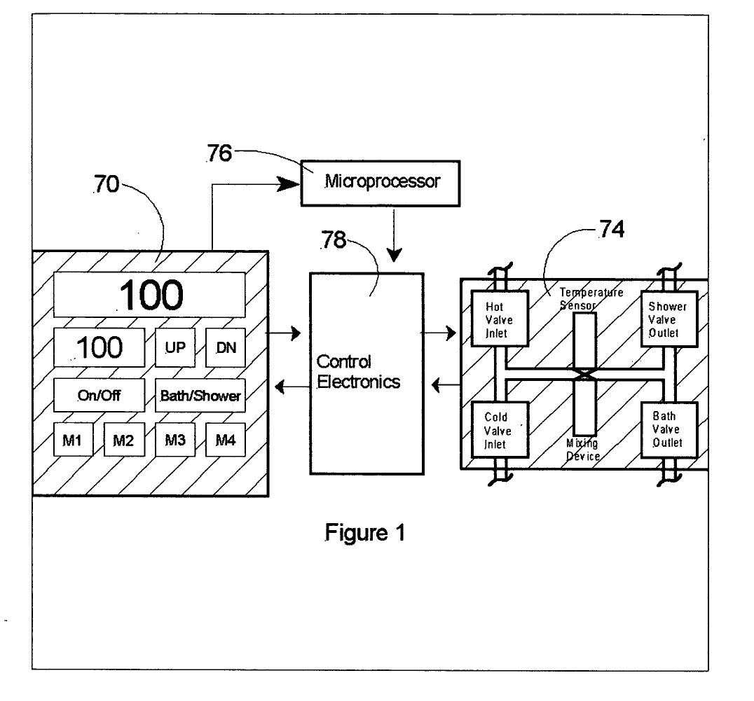

FIG. 1 is a block schematic showing the main objects of the present invention. They include but are not limited to the user interface 70, the manifold assembly 74, the microprocessor 76, and the control electronics 78. Both the user interface 70 and the manifold assembly 74 are described in detail in the following text.

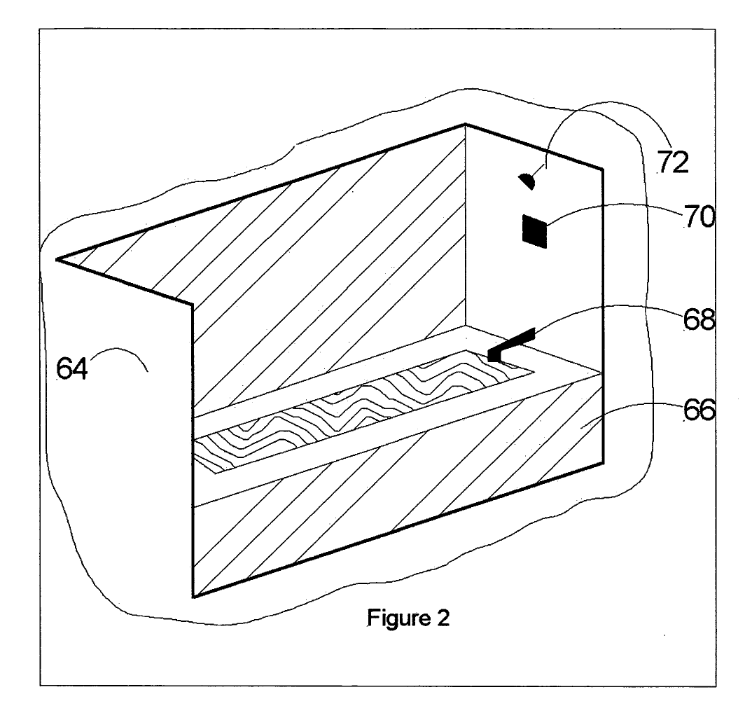

FIG. 2 depicts a typical shower and bathtub configuration 64 that includes a bathtub 66 with both a showerhead 72 and a bath faucet 68. The present invention intends to replace the typical manual knobs with a user interface 70 that will electrically control high flow proportional solenoid valves to deliver a desired water temperature.

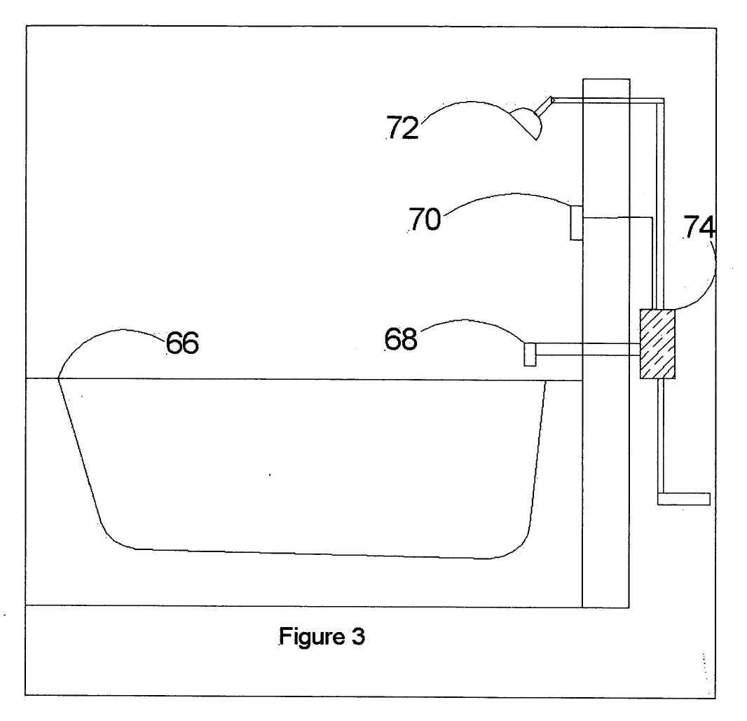

FIG. 3 shows a side view of the present invention installed in a typical shower and bath arrangement. The user interface 70 may be located anywhere within given wiring distance to the manifold assembly 74. The manifold assembly 74 will be secured to a stud behind the shower wall. The general configuration of both the user interface and the manifold assembly will be described in the following text.

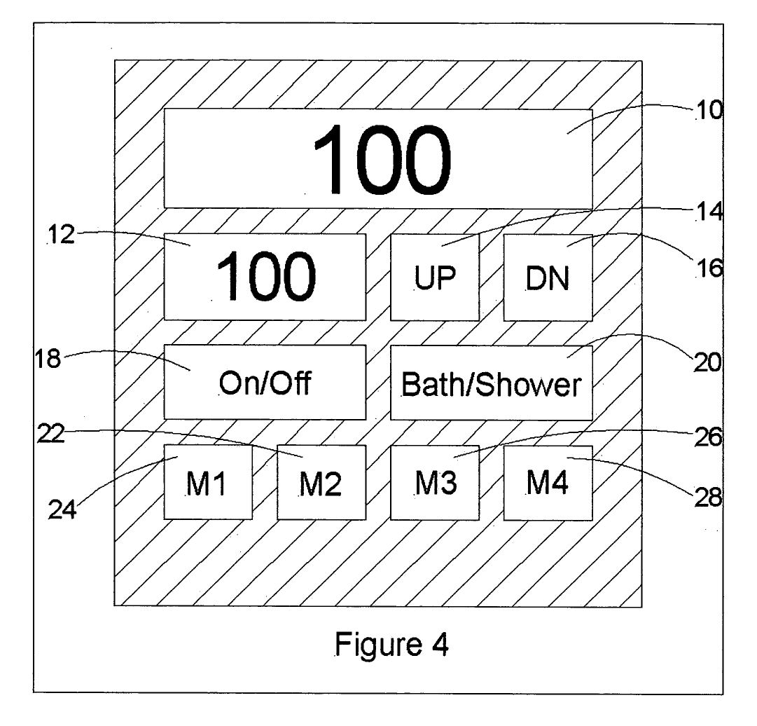

FIG. 4 illustrates a user control interface that will display the current temperature 10 of the secondary fluid. Another display 12 may be provided to display the current set point. The user interface will house a series of membrane switches that are isolated from all moisture effects of the environment and will send low voltage DC signals to the control electronics. The control electronics will use DC signals for communication to the manifold assembly. Switches 14 and 16, illustrated with up and down arrows, may be used to control the desired output temperature in incremental movements. Switch 18 will be used to toggle the manifold assembly between active and inactive control states. Switch 20 will activate either the bath or shower outlet valve to divert water to the desired location. This action will only be used in conjunction with the manifold assembly being in an active state. Memory buttons 22, 24, 26, 28 will be used to store desired temperature settings into memory such that a user can activate a memory switch to preset a desired temperature. The user interface will be controlled by a microprocessor 76 shown in FIG. 1. The microprocessor 76 shall control the user input and output to the control interface.

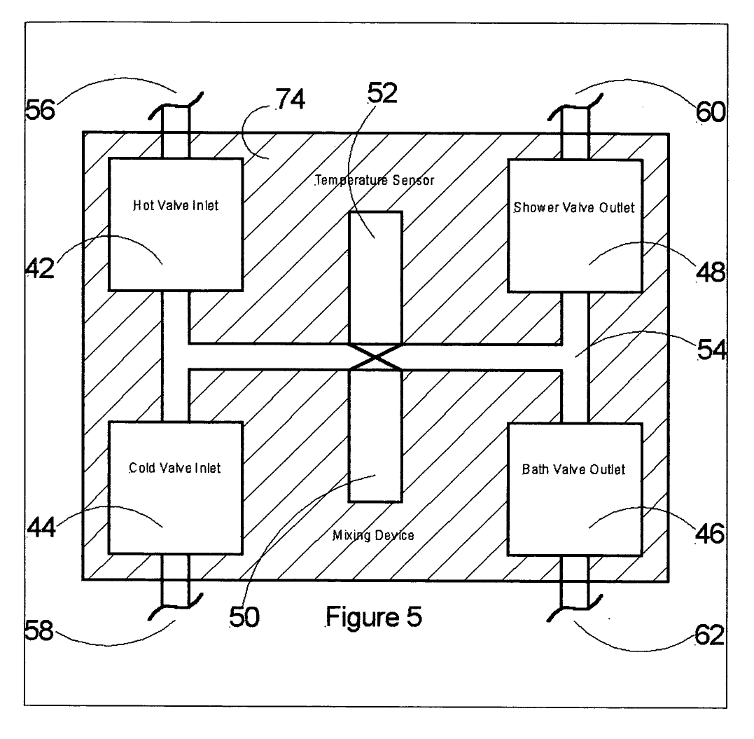

FIG. 5 illustrates the objects that may be used in the manifold assembly 74. Two electrically operated high flow proportional valves 42, 44 will be used to control the flow of the Hot and Cold water inlets 56, 58. Each valve will be independently controlled via changes to the excitation current signals to produce a varying flow to the common area 54. The signal to each valve will be electronically determined to produce varying excitation current that changes the amount of flow coming through the valves 42, 44. A mixing device 50 will be used to properly mix the two primary fluids such that the secondary fluid will be constant. A temperature signal 52 will be used by the control electronics as a feedback to determine new excitation current signals sent to the inlet valves. The mixed secondary fluid will flow through the manifold assembly and be diverted through either the shower valve outlet 60 or the bath valve outlet 62. The inlet valves have been designed to be normally closed, high flow, proportional solenoid valves, while the outlet valves are typical, normally closed, high flow solenoid valves that are commercially available.

1. A water control system for controlling the temperature and flow to an end user comprising:
A manifold assembly having a hot water inlet, a cold water inlet, a mixed water output to one or more outlets, a mixing device, and a temperature sensor;
A modular control device having a user interface, control electronics, power source, and conducting wire to control the operation of said manifold assembly.

2. A manifold assembly according to claim 1 wherein said hot water inlet is a high flow proportional solenoid valve responsive to a control signal generated by said control electronics.

3. A manifold assembly according to claim 1 wherein said cold water inlet is a high flow proportional solenoid valve responsive to a control signal generated by said control electronics.

4. A manifold assembly according to claim 1 wherein said mixed output would be directed to either an outlet, or one or more additional solenoid valves to direct the flow of said mixed water output.

5. A manifold assembly according to claim 1 wherein said mixing device is selected from the group consisting of an in-line mixing fixture to disrupt the flow of water and cause turbulence, a passive agitator that moves with the flow of water, or a motor driven assembly.

6. A manifold assembly according to claim 1 wherein said temperature sensor is selected from the group consisting of a thermocouple, a thermistor, a resistance temperature detector (RTD), an integrated circuit temperature sensor, or a fluid-pressure transducer.

7. A modular control device according to claim 1 wherein said user interface comprises a series of buttons and displays.

8. A user interface according to claim 7 wherein said buttons are inputs to the control electronics for setting desired temperature, flow rate, locality of flow, timing, radio stations, preset temperatures into memory, maximum temperature allowed, or any other desired input to the control electronics.

9. A user interface according to claim 7 wherein said displays are used to display information to the user such as temperature set point, actual temperature, timing, radio stations, maximum temperature set point or any other desired output to the user and are selected from the group consisting of LED's or LCD's.

10. A modular control device according to claim 1 wherein said control electronics receive a desired temperature set point from said user interface and a temperature variable from said temperature sensor and produce variable excitation current control signals to both the hot inlet solenoid valve and the cold inlet solenoid valve.

11. Control electronics according to claim 10 wherein said excitation current signals are produced by either a microprocessor or an arrangement of electronic components.

12. Excitation current signals according to claim 11 are produced by one or more methods from the group consisting of Pulse Width Modulated output signals or current limiting electronics.

13. A modular control device according to claim 1 wherein said power source is selected from the group consisting of Alternating Current (AC), Alternating Current (AC) to Direct Current (DC) transformation, or Direct Current (DC) from a battery source.
